(19) United States
(12) Patent Application Publication
(10) Pub. No.: US 2026/0313650 A1
(43) Pub. Date: Oct. 8, 2026

(54) XR-SPECIFIC UCI ENCODING AND MULTIPLEXING PROCEDURES

(71) Applicant: Google LLC, MOUNTAIN VIEW, CA (US)

(72) Inventors: Abdellatif SALAH, Cambridge (GB); Chih-Hsiang WU, Taoyuan City (TW)

(21) Appl. No.: 19/480,443

(22) PCT Filed: May 14, 2024
(86) PCT No.: PCT/US2024/029265

§ 371 Date: Oct. 31, 2025

Related U.S. Application Data
(60) Provisional application No. 63/502,336, filed on May 15, 2023.

(51) Int. Cl. H04W 72/21; H04L 1/1829; H04W 72/232

(52) U.S. Cl. CPC H04W 72/21; H04L 1/1864; H04W 72/232

(57) ABSTRACT

A user equipment (UE), which is configured to not jointly encode information about transmission occasions usage and an acknowledgement indication into data transmitted in the same transmission occasion, decides the manner of handling transmission of the information and the acknowledgement indication depending on one or more predetermined rules.

### FIELD OF THE DISCLOSURE

This document generally describes methods and devices operating in wireless communication systems such as (but not limited to) the ones described in standard documents, known as 3GPP communication systems.

### BACKGROUND

A user equipment (UE), is a device which allows a user's access to network services. UEs may communicate with network devices providing extended Reality (XR) services. XR is an umbrella term that covers Augmented Reality (AR), Virtual Reality (VR) and Mixed Reality (MR). In VR, a user is fully immersed in a virtual environment that is totally substituting a user's real environment typically by wearing a head-mounted device. AR augments the perception of a user's real environment with some virtual elements, in other words, some virtual elements are overlaid on the perception of the real environment. MR is an extension of AR where the real and virtual elements can interact in real time. While not necessarily always associated with XR, Cloud gaming operates video games on remote servers without the need for a gaming console or a high-end CPU and/or GPU to play these games. Cloud gaming streams a game in a manner similar to streaming a video, and the game responds to a gamer's commands and controls in real time.

Wireless implementation of Cloud gaming and/or XR offer an improved freedom of movement for the user. This improved freedom of movement occurs as wireless implementation eliminates the geographical and/or typical behavioral restrictions of a user, in other words, the wireless implementation allows a user to move more freely. Wireless XR also enables new applications. For example, for areas that do not have a decent broadband connection, remote education in immersive environments can still be provided. Multiple XR applications and scenarios can be deployed. For example, offline sharing of three-dimensional (3D) objects and 3D MR scenes among users, e.g., using a UE equipped with a depth camera to capture an image in 3D and then share it with a friend. For another example, there is VR conference in which people interact in a virtual environment and share a 3D experience with each other. The amount of XR data may be very large and may have variable size due to the variability in the video frame content. Generally, XR traffic is affected by from jitter due to the delay variations at the codec to encode the video frames.

Since XR traffic (in particular uplink AR) requires large bursts of data be transmitted fast and reliably, a throughput capacity problem may occur. The network may alleviate this problem by using configured but foreseeably unused radio resources. For example, the NE transmits, to the UE, a configured grant, CG, for physical uplink shared channel, PUSCH, resources, which indicates the UE having CG PUSCH occasions (also called transmission occasions, TOs in this document) during certain CG periods. In earlier systems, there was a single TO in each CG period, but recently there are plural occasions in each CG period. While in the earlier systems transmissions could have different sizes and jitter, the more recent approach is each TO having the same size, e.g., the maximum size the UE is able to handle. The UE may then provide information regarding configured but foreseeably unused TOs. At times, the UE may have to also report downlink-related feedback (i.e., acknowledgements). The UE may or may not be configured to jointly encode the information regarding configured but foreseeably unused TOs and the acknowledgement.

### SUMMARY

According to various embodiments, a UE, which is configured to not jointly encode information (e.g., uplink control information UCI) regarding configured but foreseeably unused TOs (UTO-UCI) and acknowledgements (HARQ-ACK/NACK) for transmission in the same TO (e.g., CG-PUSCH occasion), decides the manner of handling a situation in which both HARQ-ACK/NACK and UTO-UCI come due depending on one or more predetermined rules. In some embodiments, the UE transmits one of the HARQ-ACK/NACK and UTO-UCI and defers (and potentially later drops) the other one. The UE may send a request for UL resources for transmitting the deferred one of the HARQ-ACK/NACK and UTO-UCI or the base station may send an UL scheduling DCI for transmitting the deferred one of the HARQ-ACK/NACK and UTO-UCI. In one embodiment, the UE transmits HARQ-ACK/NACK via physical uplink control channel, PUCCH, instead of PUSCH. Network entities, NEs, are configured to cooperate with such UEs.

The UE providing information and acknowledgement to the network effectively even if the UE is not able to encode them jointly improves resource usage for transmitting data associated with extended Reality in a wireless communication network.

### BRIEF DESCRIPTION OF THE DRAWINGS

The accompanying drawings, which are incorporated in and constitute a part of the specification, illustrate one or more embodiments and, together with the description, explain these embodiments.

FIG. 1 shows a graph of video traffic versus time in a conventional wireless system.

FIG. 2 is a block diagram of a wireless communication system configured to operate according to an embodiment.

FIG. 3 graphically illustrates multiple CG-PUSCH occasions for transmitting data in a predetermined period.

FIG. 4 illustrates a CG uplink transmission during which both UTO-UCI and a HARQ-ACK/NACK are due to be transmitted during the same TO.

FIG. 5 is a signalling diagram for a first scenario according to an embodiment.

FIG. 6 is a signalling diagram for a second scenario according to an embodiment.

FIG. 7 is a signalling diagram for a third scenario according to an embodiment.

FIG. 8 is a signalling diagram for a fourth scenario according to an embodiment.

FIG. 9 is a flowchart of a communication method performed by a UE in a wireless communication network according to an embodiment.

FIG. 10 is a flowchart of a communication method performed by a NE in a wireless communication network according to an embodiment.

### DETAILED DESCRIPTION

Methods and devices described in this section embody techniques related to XR-specific UCI encoding and multiplexing.

XR traffic has been conventionally modelled as including two UE traffic flows. Traffic flow 1 is typically used for the downlink (DL) VR traffic or the uplink (UL) AR traffic and traffic flow 2 used for pose/control information.

Traffic flow 1 is a quasi-periodic traffic which is designed to achieve or control some of the following properties: periodicity of frames, jitter associated with data packets, packet size, bit rates, latency and packet loss. Typical rate for traffic flow 1 is 30 fps (frame-per-second), 60 fps and/or 120 fps. Jitter (which is a displacement or a deviation with respect to a reference time) is in a range of +/−4 ms (millisecond) and may have a gaussian distribution. Jitter for UL is smaller than for downlink, but it is always present especially for the case of tethering devices (e.g., if a modem is part of the UE and images are displayed on AR glasses or a VR headset). Packet sizes may be variable and may also have a truncated gaussian distribution. Depending on frame rate, resolution, codec efficiency, etc., bit rates associated with XR traffic are between 10 Mbps and 200 Mbps. Packet loss rate should be lower than 10E−3. Latency requirement is 10 ms. It is to be understood that these property descriptions are only examples and are not intended to be limiting. For example, traffic flow 1 is used when a user uploads a picture of a sofa and an image a room to an XR server, which then integrates the picture of the sofa into the image and send the result back to the user.

Traffic flow 1 handles data bursts. A data burst may be a video frame including one or more protocol data unit, PDU, sets (a PDU being one slice of the video frame). In XR context, a UE may occasionally transmit data bursts such as video frames and/or control information to the network.

Traffic flow 2 sends pose/control information (e.g., sensor information, which reflects a user's position and movement to adjust the AR/VR content) relevant, for example, to Cloud gaming. Traffic flow 2 can be merged into Traffic flow 1. Traffic flow 2 is designed to achieve at least some of the following properties. Traffic flow 2's rate may be 4 fps, or the fps as described with respect to Traffic flow 1. There is typically no jitter associated with Traffic flow 2. Traffic flow 2 packet sizes are small, about 100 bytes. Latency requirement is 10 ms to 20 ms. Packet loss rate should be lower than the one for traffic flow 1, e.g., 10E−5. It is to be understood that these property values are only examples and are not intended to be limiting.

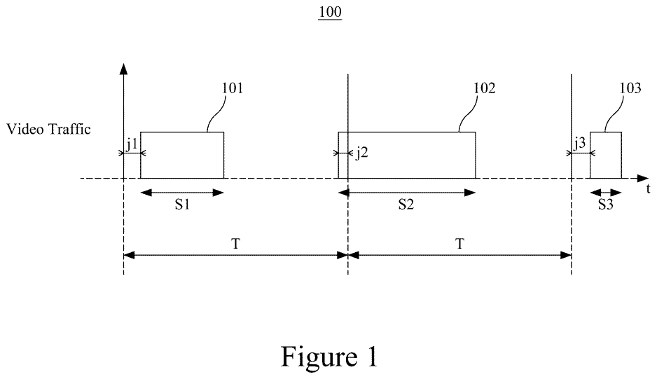

FIG. 1 is a graph 100 illustrating video traffic versus time, t. In FIG. 1, there are three video packets 101, 102, and 103 transmitted around beginnings of T periods. Packets 101, 102, and 103 have different sizes S1, S2, and S3, respectively, and different jitters d1, d2 and d3. In FIG. 1, jitter d1, d2 and d3 are drawn from a truncated Gaussian distribution which has a mean of zero ms, a standard deviation (STD) of 2 ms, and a range of [−4, +4] ms. The frame size S1, S2 and S3 are drawn from a truncated Gaussian distribution which has a mean as shown in the following equation, [STD, Max, Min] being equal to [10.5, 150, 10] % of the Mean.

$$Mean = ( average data rate ) / ( fps for video stream ) / 8 bytes$$

While some embodiments described herein are described with respect to Traffic flow 1, e.g., UL AR traffic, embodiments are not limited thereto. For example, where applicable, embodiments can be applied to usage of XR and Cloud gaming, as well as other applications in which similar data rate concerns exist for similar coding situations, e.g., where two types of information are desired to be decoded at a similar location in time and/or frequency and/or slot (e.g., when UTO-UCI and HARQ-ACK/NACK need to be jointly encoded in a similar manner for another application, or when other types of information need to be similarly encoded and transmitted).

In the context of plural CG-PUSCH occasions (TOs) in each CG period, UTO-UCI is typically conveyed (multiplexed with data) in each CG-PUSCH occasion. However, both HARQ-ACK/NACK and UTO-UCI may be due to be transmitted within the same CG-PUSCH occasion.

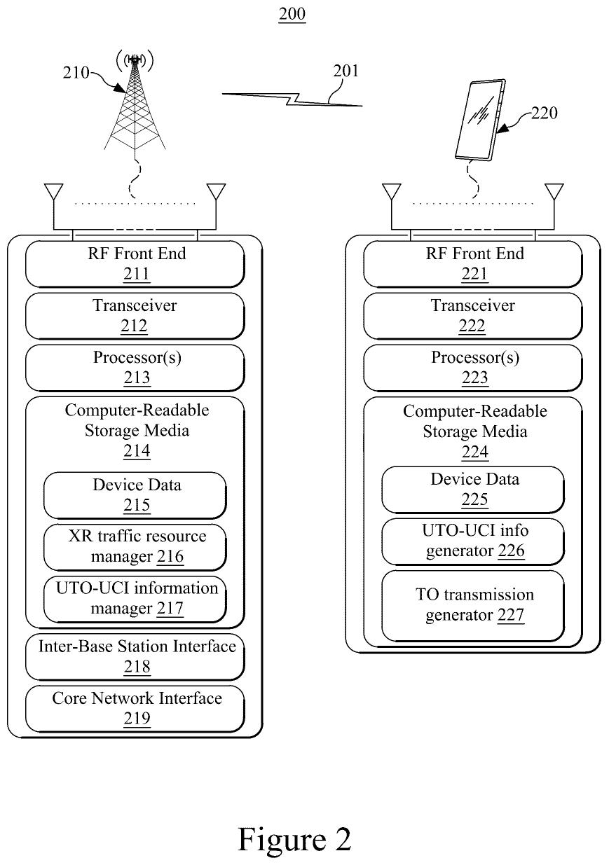

FIG. 2 illustrates a wireless communication system 200 including a UE and a NE configured to support traffic flows as described above. Methods and devices described in this section embody techniques related to, for example, XR Traffic flows, UCI encoding, downlink feedback encoding, multiplexing procedures and the like. NE 210 and UE 220 communicate wirelessly 201 and are configured to support XR traffic and related information. NE 210 may be a base station, BS, but more generally, the term “network entity” stands for a wireless device with a well-defined network functionality (e.g., BS's functionality is connecting UEs to the core network including managing communications to and from the UEs). NE 210 and UE 220 may include additional functions and interfaces omitted from FIG. 12 in the interest of brevity. Arrow 201 generally represents both uplink signals (from the UE to the NE) and downlink signals (from the NE to the UE).

NE 210 as illustrated in FIG. 2 may provide the functionality of an gNB (i.e., a 5G or 6G base station). NE 210's functionality may be distributed across multiple entities (e.g., a central unit, CU, a distributed unit, DU, and a radio unit, RU). NE 210 includes antennas, a Radio Frequency (RF) front end 211 and a transceiver 212 for communicating with UE 220 and other UEs and NEs. NE 210's antennas and RF front end 211 can be tuned to one or more frequency bands (e.g., subcarriers), for example as defined by 3GPP LTE, 5G NR, and 6G communication standards and implemented by transceiver 212.

NE 210 further includes processor(s) 213 and computer-readable storage media (CRM) 214. Processor(s) 213 can include single or multiple-core processors, and CRM 214 includes any suitable memory/storage except propagating signals. For example, memory/storage can include random-access memory (RAM), static RAM (SRAM), dynamic RAM (DRAM), non-volatile RAM (NVRAM), read-only memory (ROM), and/or flash memory. CRM 214 stores device data 215, which includes network scheduling data, radio resource management data, applications, and/or an operating system, which are executable by processor(s) 213 to enable wireless communication 201 with UE 220 as well as with other NEs and UEs.

CRM 214 also stores XR traffic resource manager 216 and UTO-UCI information manager 217. XR traffic resource manager 216 causes or supports NE 210 to perform various steps and actions for generating instructions directing UE 220 as applicable in support of some embodiments as described herein. UTO-UCI information manager 217 provides instructions and/or information as needed to UE 220 in support of some embodiments described herein associated with when to or when not to jointly encode UTO-UCI information and HARQ-ACK/NACK information.

NE 210 also includes inter-base station interface 218 and core-network interface 219. Inter-base station interface 218 can be a standardized interface, such as an Xn and/or X2 interface, for exchanging user-plane and control-plane data with another NE (e.g., in case of a handover). Core-network interface 219 enables NE's user-plane data and control-plane information exchange with core network functions and/or entities.

UE 220 includes antennas connected to a RF front end 221, and a transceiver 222. Transceiver 222 may be an LTE transceiver, a 5G NR transceiver, or another transceiver. The UE may include multiple transceivers. The antennas and RF front end 221 can be tuned to one or more frequency bands (e.g., subcarriers), for example, as defined by 3GPP LTE, 5G NR, and 6G communication standards and implemented by respective transceivers. UE 220 also includes one or more processor(s) 223, and computer-readable storage media (CRM) 224. Processor(s) 223 may be single or multiple-core processors, and CRM 224 includes any suitable memory/storage other than propagating signals. For example, memory/storage can include random-access memory (RAM), static RAM, dynamic RAM, non-volatile RAM, read-only memory (ROM), and/or flash memory. CRM 224 stores device data 225 necessary for UE's communications, UTO-UCI information generation 226 and TO transmission generator 227.

In some embodiments, the NE's XR traffic resource manager 216 and the NE's UTO-UCI information manager 217 as well as the UE's UTO-UCI information generator 226 and the UE's TO transmission generator 227 may be implemented not only as software but also as hardware logic and/or circuitry. A wireless system such as the one schematically illustrated in FIG. 2 may implement various techniques related to embodiments described hereinafter.

Recently it has been agreed to use a new type of uplink control information (UCI), that is, unused time occasion UCI (UTO-UCI) for the UE to indicate the CG occasions that are not going to be used by the UE. UTO-UCI may be transmitted within CG PUSCH occasions and may be multiplexed with the CG PUSCH. The name “UTO-UCI” is intended to be suggestive and not limiting.

UTO-UCI that carries information about the unused CG PUSCH occasions may be multiplexed with the CG PUSCH in all CG PUSCH occasions. However, if other control information (such as, HARQ-ACK) is due to be transmitted within the same CG PUSCH occasion, the UTO-UCI may be jointly encoded with the other control information, transmitted separately from the other information on another channel, dropped, or deferred. Note that in the following description “deferring” means not sending when apparently due, the term “deferring” including the option of dropping the deferred information.

The UE determines the amount of resources to be used for encoding control information (e.g., CG-UCI, UTO-UCI, HARQ-ACK/NACK feedback, or other uplink control information) into a CG-PUSCH occasion, using a parameter known as β_{offset}. β_{offset} can be configured via RRC or indicated dynamically via DCI. Thus, the network controls the amount of resources used for encoding UTO-UCI multiplexed into a CG-PUSCH occasion, and, hence, the reliability of this conveying this control information. In some embodiments, the UE determines whether UTO-UCI and HARQ-ACK are jointly encoded or not, and the manner of encoding HARQ-ACK, using a parameter

$${β}_{offset}^{HARQ - ACK}$$

that indicates the size of resources for multiplexing HARQ-ACK/NACK in PUSCH. In some embodiments,

$${β}_{offset}^{CSI 1}$$

$$and$$

$${β}_{offset}^{CSI 2}$$

determine the size of resources used to multiplex a CSI report in a PUSCH. Here, CSI1 indicates the first part of a CSI report (CSI part 1), which has a fixed payload size and is used to identify the number of information bits in the second part of the CSI report (CSI part 2). CSI2 indicates the second part of the CSI report. CSI part 1 is of higher priority and must be transmitted before CSI part 2 can be transmitted. CSI part 1 and CSI part 2 may be configured with different beta offsets.

The parameter β_{offset} of UTO-UCI encoded in CG-PUSCH occasion depends on whether UTO-UCI is jointly encoded with HARQ-ACK/NACK. If not encoded jointly, the UE uses a UTO-UCI specific β_{offset} otherwise it uses the

$${β}_{offset}^{HARQ - ACK} .$$

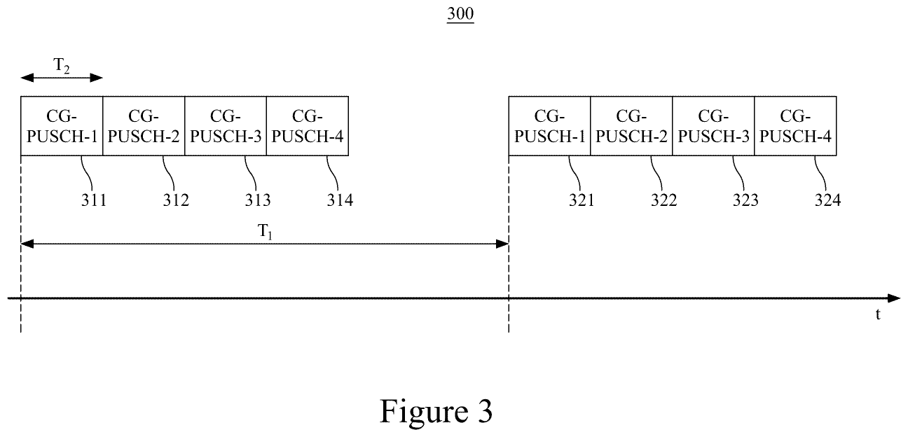

In some embodiments, XR information, e.g., UL AR information, can be of variable size, therefore using one or more occasions or CG-PUSCH blocks for transmitting information are used. FIG. 3 illustrates multiple occasions configured for transmitting data in a period. The XR traffic is a quasi-periodic traffic with a period equal to an inverse of an XR frame rate. For example, if the frame rate is 60 frames per second (fps), the periodicity is 16.67 milliseconds (ms).

FIG. 3 illustrates a first CG period T1 with four occasions (CG-PUSCH-1 311, CG-PUSCH-2 312, CG-PUSCH-3 313, and CG-PUSCH-4 314) and four other occasions (CG-PUSCH-1 321, CG-PUSCH-2 322, CG-PUSCH-3 323, and CG-PUSCH-4 324) in the next period. In this example, each of the CG-PUSCH occasions lasts T2. Although in FIG. 3 there are four occasions per period, this number of occasions is an illustration not a limitation (i.e., more or fewer occasions may be configured). Factors involved in determining the number of occasions in a period include UE's data rate, the size of data to be uploaded for each occasion, etc. Further, the duration of the occasions may be different for CGs provided to the UE in different scenarios. As used herein, the terms occasion(s) and CG-PUSCH occasion(s) are examples of a transmission occasion(s) (TO), and such terms can be interchangeable.

The use of plural occasions per period for transmitting data reduces issues associated with jitter. For example, by having more than one occasion, if jitter is high, an occasion can be skipped, with data being better synchronized in occasions following the unused occasion. For example, instead of using CG-PUSCH-1 311, a UE uses CG-PUSCH-2 312, synchronization is improved (jitter reduced) in the later occasion. In this way, only a portion of a CG period (in this example, the one corresponding to CG-PUSCH-1 311) is lost instead of wasting the entire period if excessive jitter prevents recipient device from using the transmitted data.

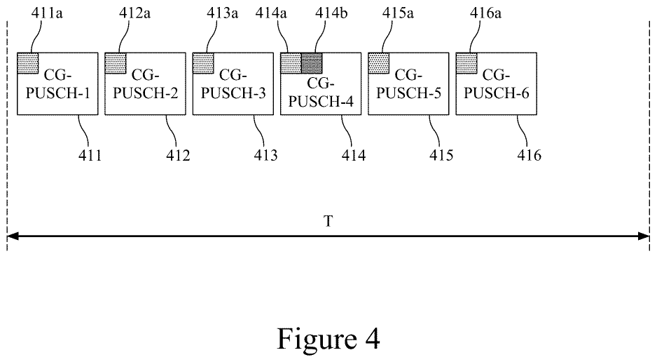

FIG. 4 illustrates a CG uplink transmission including a CG-PUSCH occasion during which both UTO-UCI and a HARQ-ACK/NACK are due to be transmitted. Each of the CG-PUSCH occasions 411, 412, 413, 414, 415, and 416 in FIG. 4 includes a UTO-UCI field 411a, 412a, 413a, 414a, 415a, and 416a, respectively. HARQ-ACK/NACK 414b is also due to be transmitted in CG-PUSCH-4 414. Some UEs are configured to jointly encode UTO-UCI and HARQ-ACK/NACK. However, some UEs are not configured to jointly encode UTO-UCI and HARQ-ACK/NACK, so a CG-PUSCH such as 414 can be used to transmit only one of UTO-UCI and HARQ-ACK/NACK. That is, the CG-PUSCH 414 is used to transmit UTO-UCI or HARQ-ACK/NACK but not both. UE's behaviour according to various embodiments when both UTO-UCI and HARQ-ACK/NACK are due is described in more detail below.

The UE that is configured to not jointly encode UTO-UCI and HARQ-ACK/NACK may receive an uplink resource allocation via a CG Type 1 or via a CG Type 2. For a Type 1 CG, an RRC message directly provides the configured uplink grant (including the periodicity) to the UE. For a Type 2 CG, an RRC message defines the periodicity of the configured uplink grant, while a PDCCH message (DCI) can signal and/or activate the use of the uplink resources.

In an embodiment, the UE applies parameter

$${β}_{offset}^{UTO - UCI}$$

to determine the number of uplink resources within an occasion to be used for multiplexing the UTO-UCI information. The UE that doesn't jointly encode UTO-UCI and HARQ-ACK/NACK may drop HARQ-ACK/NACK or may transmit it on another PUSCH transmission (e.g., send the HARQ-ACK/NACK on another CG PUSCH occasion either in a same CG period or in a different CG period). Dropping HARQ-ACK/NACK may undesirably cause waste of downlink resources for retransmitting the data to be acknowledged by the HARQ-ACK/NACK.

If the HARQ-ACK/NACK transmission is deferred, the NE might schedule a specific UL grant (or an UL assignment) to receive the deferred HARQ-ACK/NACK. The UE may send a request to the NE asking for UL resources be allocated for transmitting the deferred HARQ-ACK/NACK. An amount of data to be transmitted may be a factor in determining whether to defer or drop the deferred HARQ-ACK/NACK.

More generally yet including some of the above-described features, a UE, which is configured to not jointly encode UTO-UCI and HARQ-ACK/NACK for transmission in the same CG-PUSCH occasion, decides the manner of handling HARQ-ACK/NACK and UTO-UCI that come due to be transmitted in the same CG-PUSCH occasion depending on one or more predetermined rules. The UE transmits one of the HARQ-ACK/NACK and UTO-UCI and defers the other one. The UE may send a request for UL resources for transmitting the deferred one of the HARQ-ACK/NACK and UTO-UCI or the NE may send an UL scheduling DCI (to assign resources) for transmitting the deferred one of the HARQ-ACK/NACK and UTO-UCI. In yet another embodiment the UE abandons the CG-related transmission altogether and transmits HARQ-ACK/NACK via physical uplink control channel, PUCCH.

In some embodiments, the UE receives an indicator of

$${β}_{offset}^{UTO - UCI}$$

value from the NE. The value may pertain to a set of predefined values. The indicator may be an index enabling receiving

$${β}_{offset}^{UTO - UCI}$$

value from an indexed table of values.

In an embodiment, the UE applies corresponding

$${β}_{offset}^{HARQ - ACK}$$

to determine the number of resources for multiplexing the HARQ-ACK/NACK in the PUSCH while dropping or deferring the UTO-UCI information (e.g., sending it on another PUSCH transmission). When the UTO-UCI is deferred, the NE may provide a specific UL grant to the UE, for receiving the deferred UTO-UCI. An amount of data to be transmitted, the size of HARQ-ACK/NACK (e.g., number of bits), the size of the UTO-UCI, the priority of the HARQ-ACK/NACK, if the HARQ-ACK/NACK is associated to an URLLC, XR, or eMBB traffic, and/or a combination of these factors may be used to determine whether to defer (and potentially drop) or not to defer HARQ-ACK/NACK.

In an embodiment, if the PUSCH transmission is a CG Type 2 PUSCH (i.e., a transmission configured via a CG Type 2) and if the UE doesn't jointly encode UTO-UCI and HARQ-ACK/NACK, the CG activation DCI includes an UTO-UCI beta-offset indicator field with N bits (e.g., N=1, 2, or 4). Number N in the DCI bit-field may be configured via a dedicated RRC parameters (e.g., new parameter uto-uci-OnPUSCH or the existing uci-OnPUSCH parameter).

In an embodiment, the number of bits N in the DCI bit-field may be fixed and pre-defined. Alternatively, number N could be derived from the size of a pre-defined UTO-UCI beta-offset table, e.g., if the size of a pre-defined UTO-UCI beta-offset table is four, then N=2, however, embodiments are not limited thereto.

In one embodiment, number N in the DCI bit-field could be determined from a semi-statically configured UTO-UCI beta-offset table. For example, if the semi-statically configured UTO-UCI beta-offset table has four entries, then N=2.

In an embodiment, if the PUSCH transmission is a CG Type 1 PUSCH and if the UE does not jointly encode UTO-UCI and HARQ-ACK/NACK, the UE receives an UTO-UCI beta-offset indicator value (e.g., via an RRC message) pertaining to a set of pre-defined values.

In an embodiment, when the UE jointly encodes the UTO-UCI and HARQ-ACK/NACK, the beta-offset value could be determined based on the combined payload size of these two messages and/or based on the configured beta-offset values for HARQ-ACK.

In an embodiment, for a PUSCH transmission that is configured by a ConfiguredGrantConfig and includes UTO-UCI, the UE jointly encodes the HARQ-ACK/NACK information and the UTO-UCI and determines a number of resources for multiplexing the combined information in a PUSCH using

$${β}_{offset}^{HARQ - ACK}$$

In an embodiment, if the PUSCH transmission is a configured grant Type 2 PUSCH and if UTO-UCI and HARQ-ACK/NACK are not jointly encoded, the UE applies the

$${β}_{offset}^{UTO - UCI}$$

values that are determined from a new parameter, e.g., a first value of parameter UTO-UCI-OnPUSCH=‘dynamic’.

In an embodiment, a new table is defined for the

$${β}_{offset}^{UTO - UCI}$$

values, and different values of

$${β}_{offset}^{UTO - UCI}$$

values can be adopted for each index indicator

$${I}_{offset}^{UTO - UCI} . {β}_{offset , k}^{UTO - UCI}$$

values may be decimal values or reserved values. Table 1 illustrates mapping of M beta-offset values for UTO-UCI and index values that may be provided by higher layers (e.g., RRC). The values shown in Table 1 are examples only, and embodiments are not limited thereto.

TABLE 1

| ${I}_{offset}^{UTO - UCI}$ | ${β}_{offset}^{UTO - UCI}$ |
|---|---|
| 0 | ${β}_{offset , 0}^{UTO - UCI}$ |
| 1 | ${β}_{offset , 1}^{UTO - UCI}$ |
| . . . | . . . |
| k | ${β}_{offset , k}^{UTO - UCI}$ |
| . . . | . . . |
| M | ${β}_{offset , M}^{UTO - UCI}$ |

While the above descriptions have focus on NE to UE communication, the described methods may be used in side-link communications context (e.g., when a UE communicates with VR headset or AR glasses and the like) for side-link control information. In side-link communications context, DCI is replaced with side-link control information, SCI.

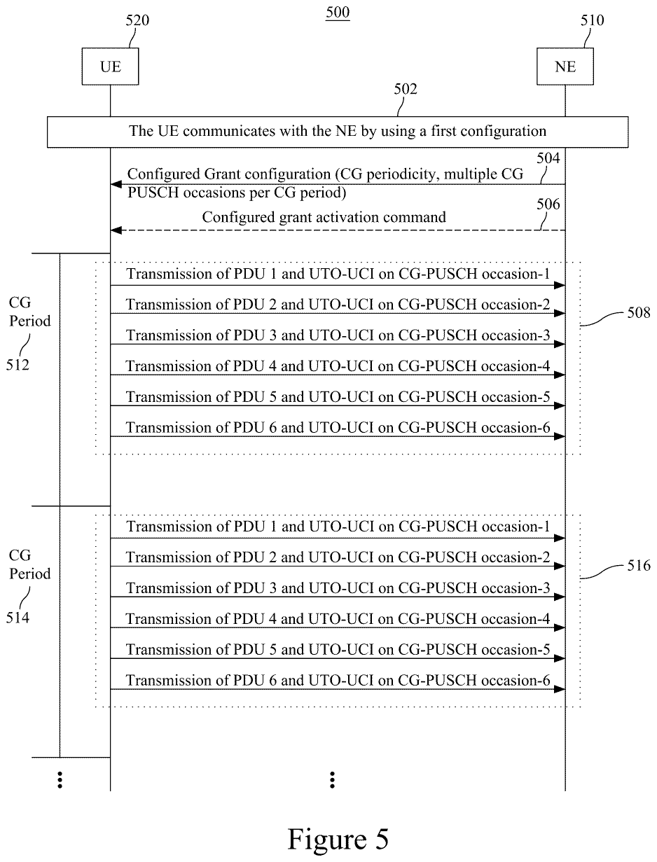

Signalling diagrams illustrating signals exchanged between, a UE (which may have the structure illustrated in FIG. 2) and an NE according to various scenarios, are now described with respect to FIGS. 5-8. In FIGS. 5-8, it is to be understood that time flows from top to bottom, in other words, the topmost signal occurs before the signals illustrated lower.

Signalling diagram 500 in FIG. 5 corresponds to a scenario in which UTO-UCI is transmitted in each CG-PUSCH occasion and no HARQ-ACK/NACK comes due. Initially, UE 520 communicates 502 with the NE 510 by using a first configuration. NE 510 then transmits 504 a configured grant (e.g., including CG periodicity, number of CG PUSCH occasions per CG period) to UE 520. NE 510 may activate 506 the CG via a CG activation command (e.g., a DCI message) transmitted to the UE 520. During a CG period 512, UE 520 uses the configured CG-PUSCH occasions to transmit 508 PDUs and UTO-UCIs. During a CG period 514, UE 520 uses the configured CG-PUSCH occasions to transmit 516 PDUs and UTO-UCIs. FIG. 5 illustrates two CG periods 512 and 514 (each period including six used CG-occasions), but this is just an example not intended to be limiting.

Signalling diagram 600 corresponds to a scenario in which UE 620 is configured to jointly encode the UTO-UCI and HARQ-ACK/NACK. As in the previous scenario in FIG. 5, UE 620 initially communicates 602 with the NE 610 using a first configuration. NE 610 then provides 604, a CG configuration. NE 610 may activate 606 the CG via a CG activation command transmitted to the UE 620. During CG period 612, UE 620 uses first three configured CG-PUSCH occasions to transmit 608a PDUs and UTO-UCIs. Upon receiving 605 downlink data, since a HARQ-ACK/NACK becomes due 607 for transmission, UE 620 jointly encodes 609 HARQ-ACK/NACK, UTO-UCI, and PDU 4. UE 620 then transmits 608B PDU 4 with the jointly encoded HARQ-ACK/NACK and UTO-UCI, PDU 5 with UTO-UCI, and PDU 6 with UTO-UCI, using the rest of CG-PUSCH occasions in CG period 612. During CG period 614, UE 620 uses the configured CG-PUSCH occasions to transmit 616 PDUs and UTO-UCIs. While two CG periods 612 and 614 are shown, it is to be understood that this is just an example.

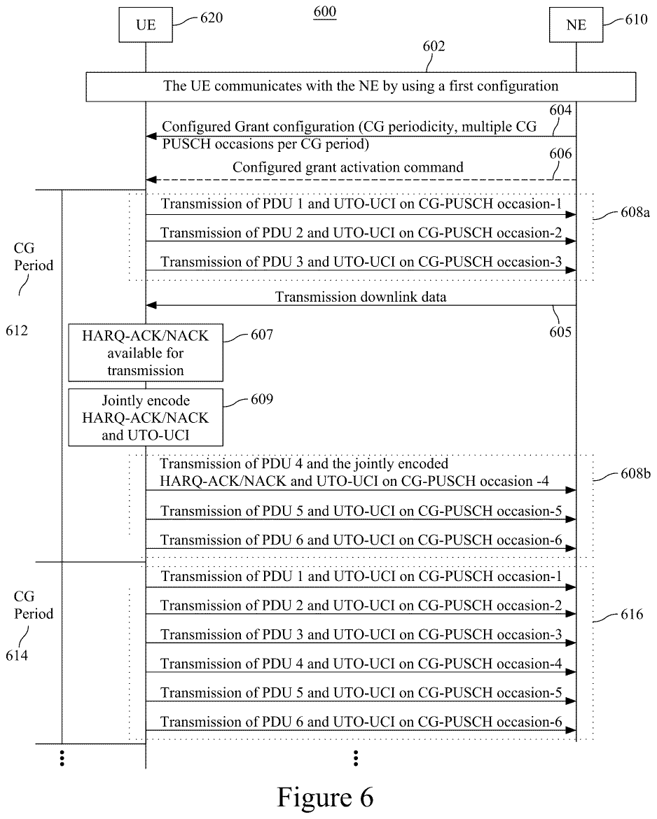

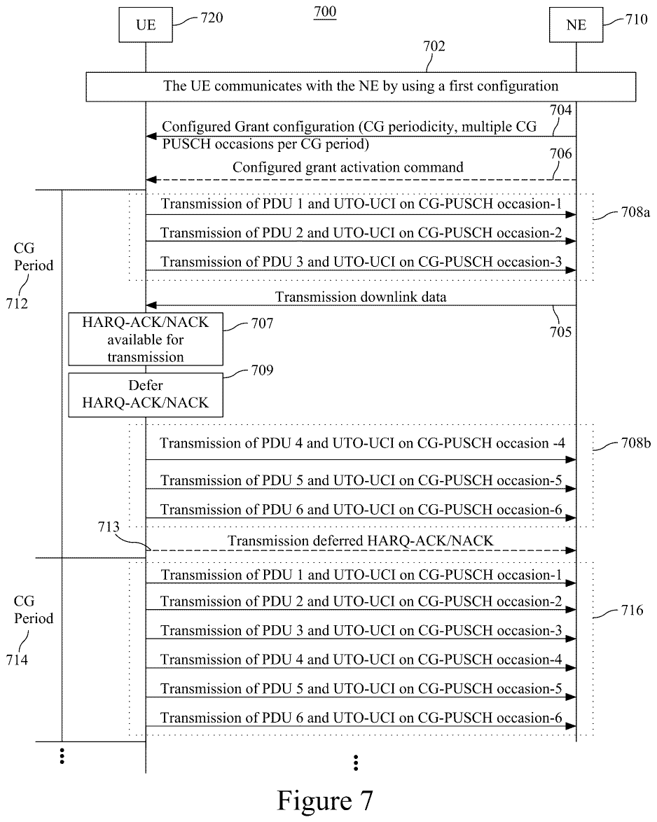

Signalling diagram 700 in FIG. 7 corresponds to a scenario in which UE 720 is configured not to jointly encode UTO-UCI and HARQ-ACK/NACK. Signals 702, 704, 706, and 708a are similar to signals 602, 604, 606, and 608a described above in FIG. 6. Upon receiving 705 downlink data, since HARQ-ACK/NACK becomes due (available) 707 for transmission. UE 720 decides 709 to defer the HARQ-ACK/NACK. The UE may transmit 713 the deferred HARQ-ACK/NACK (option suggested using a dashed line). Alternatively, the UE may drop the HARQ-ACK/NACK (not shown). In scenario 700, UE 720 transmits 708B PDU 4 with UTO-UCI, PDU 5 with UTO-UCI, and PDU 6 with UTO-UCI, using the rest of CG-PUSCH occasions in CG period 712. Then, during CG period 714, UE 720 uses the configured CG-PUSCH occasions to transmit 716 PDUs and UTO-UCIs. While two CG periods 712 and 714 are shown, it is to be understood that this is just an example.

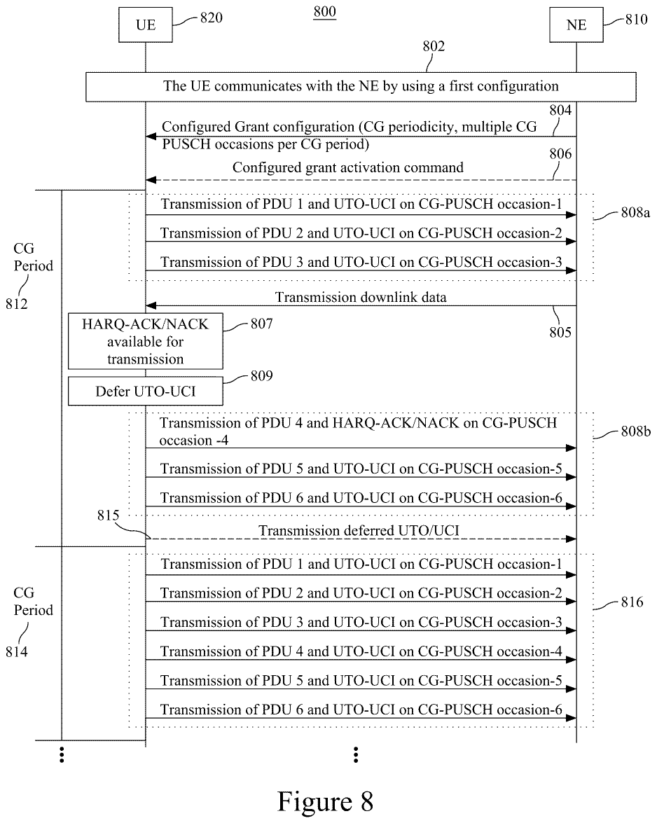

Signalling diagram 800 in FIG. 8 corresponds to another scenario in which UE 820 is configured not to jointly encode UTO-UCI and HARQ-ACK/NACK. Signals 802, 804, 806, and 808a are similar to signals 602, 604, 606, and 608a described above in FIG. 6. Upon receiving 805 downlink data, since HARQ-ACK/NACK becomes due (available) 807 for transmission, UE 820 decides 809 to defer the UTO-UCI. The UE may transmit 815 the deferred UTO-UCI (option suggested using a dashed line). Alternatively, the UE may drop the UTO-UCI (now shown). In this scenario, UE 820 then transmits 808B PDU 4 with HARQ-ACK/NACK, PDU 5 with UTO-UCI, and PDU 6 with UTO-UCI, using the rest of CG-PUSCH occasions in CG period 812. Then, during CG period 814, UE 820 uses the configured CG-PUSCH occasions to transmit 816 PDUs and UTO-UCIs. While two CG periods 812 and 814 are shown, it is to be understood that this is just an example.

In one embodiment, instead of transmitting UTO-UCI information multiplexed with CG-PUSCH, a UE may drop an entire CG-PUSCH and UTO-UCI if they overlap with the PUCCH, and instead transmit a PUCCH carrying the HARQ-ACK/NACK. In other words, in this scenario, the UE prioritizes transmitting HARQ-ACK/NACK over both CG-PUSCH and UTO-UCI. In one embodiment, HARQ-ACK/NACK and UTO-UCI can be jointly encoded and transmitted on PUCCH while the PUSCH data is dropped.

In some embodiments, UE indicates its capability and the NE configures UE to jointly encode of UTO-UCI and HARQ-ACK/NACK via semi-static signalling (e.g., using an RRC configuration) or via dynamic signalling (e.g., using a DCI message).

In some embodiments, UE indicates to the NE in a UE capability message (e.g., semi-staticBetaOffsetInd-UTO-UCI parameter), whether UE supports indicating beta-offset for UTO-UCI via an RRC configuration. In some other embodiments, UE indicates to the NE in a UE capability message (e.g., dynamicBetaOffsetInd-UTO-UCI parameter), whether UE supports indicating beta-offset for UTO-UCI via DCI among the RRC configured betaoffsets for UTO-UCI.

In some embodiments, whether the UE jointly encodes UTO-UCI and HARQ-ACK/NACK depends on HARQ-ACK/NACK characteristics, such as, priority, associated traffic, size/payload, and the like. For example, if the HARQ-ACK/NACK is associated with XR traffic, HARQ-ACK/NACK can be jointly encoded with UTO-UCI and transmitted on CG-PUSCH. If HARQ-ACK/NACK is associated with Enhanced Mobile Broadband (eMBB) traffic, HARQ-ACK/NACK could be deferred and, optionally, dropped. For another example, if HARQ-ACK/NACK is feedback related to high priority traffic, HARQ-ACK/NACK is jointly encoded with UTO-UCI and transmitted on CG-PUSCH. If HARQ-ACK/NACK is feedback related to low priority traffic, HARQ-ACK/NACK is deferred (and may be dropped). In yet another example, whether HARQ-ACK/NACK is jointly encoded with UTO-UCI and transmitted on CG-PUSCH depends on a payload size of the transmission for which HARQ-ACK/NACK provides feedback. For example, a payload size threshold could be defined or configured by the base station to the UE, if size of the HARQ-ACK/NACK in bits is below the payload size threshold then HARQ-ACK/NACK is jointly encoded with the UTO-UCI and if not then the HARQ-ACK/NACK is deferred (or may be dropped).

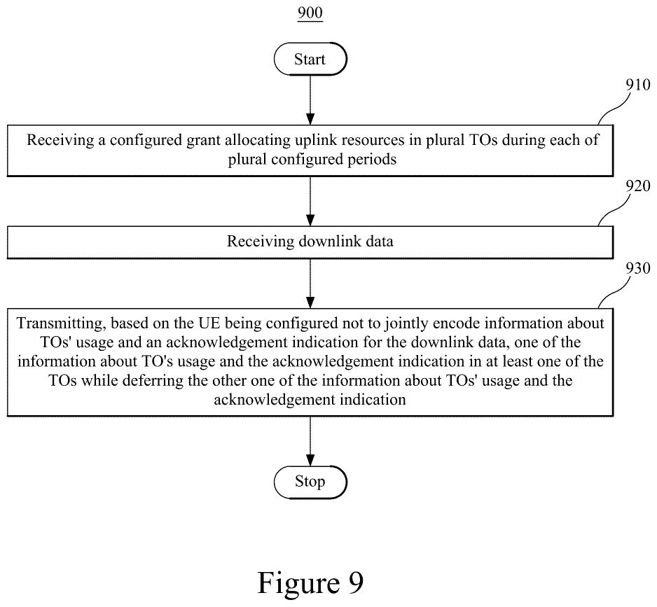

According to an embodiment, referring to FIG. 9, there is a wireless communication method 900 performed by a UE (such as, 220, 720 and 820) in a wireless communication network (e.g., 200). Method 900 includes receiving 910 a configured grant allocating uplink resources in plural TOs during each of plural configured periods (such as in 702, 802 optionally with 704, 804, respectively). Method 900 further includes receiving 920 downlink data (e.g., 705, 805), and transmitting 930, based on the UE being configured not to jointly encode information about TOs' usage and an acknowledgement indication for the downlink data, one of the information about TOs' usage and the acknowledgement indication in at least one of the TOs while deferring the other one of the information about TOs' usage and the acknowledgement indication (e.g., transmitting PDU 4 with UTO-UCI or HARQ-ACK/NACK within 708b, 808b).

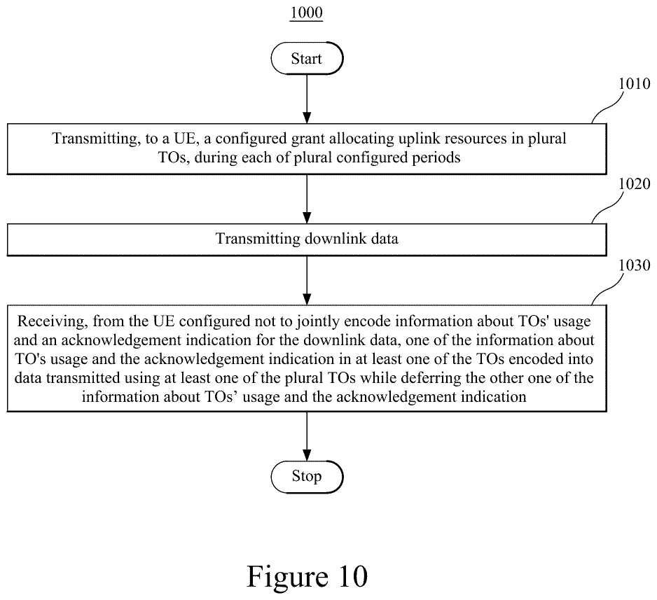

According to another embodiment, referring to FIG. 10, there is a wireless communication method 1000 performed by an NE (such as 210, 710, 810). Method 1000 includes transmitting 1010, to a UE (e.g., 220, 720, 820) a configured grant allocating uplink resources in plural TOs during each of plural configured periods (such as in 702, 802 optionally with 704, 804, respectively). Method 1000 further includes transmitting 1020 downlink data to the UE (e.g., 705, 805) and receiving 1030), from the UE configured not to jointly encode information about TOs' usage and an acknowledgement indication for the downlink data, one of the information about TOs' usage and the acknowledgement indication for the downlink data encoded with uplink data transmitted during one of the TOs (e.g., receiving PDU 4 with UTO-UCI or HARQ-ACK/NACK within 708b, 808b), while deferring the other one of the information about TOs' usage and the acknowledgement indication.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

A user device in which the techniques of this disclosure can be implemented (e.g., the UE 220, 520, 620, 720, 820) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

When implemented in software, the techniques can be provided as part of the operating system, a library used by multiple applications, a particular software application, etc. The software can be executed by one or more general-purpose processors or one or more special-purpose processors. For example, a wireless communication device can include a transceiver, a processor and computer-readable storage media which stores executable instructions for the processor to perform any of the embodiments and/or combinations of the embodiments described herein.

Upon reading this disclosure, those of skill in the art will appreciate additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

### Example 1

A wireless communication method (900) performed by a UE includes: receiving (910) a configured grant allocating uplink resources in plural transmission occasions, TOs, during each of plural configured periods, receiving (920) downlink data, and transmitting (930), based on the UE being configured not to jointly encode information about TOs' usage and an acknowledgement indication for the downlink data, one of the information about TOs' usage and the acknowledgement indication in at least one of the TOs while deferring the other one of the information about TOs' usage and the acknowledgement indication.

### Example 2

The wireless communication method of example 1 further includes the UE transmitting the deferred one of the information about TOs' usage and the acknowledgement indication using another uplink transmission.

### Example 3

The wireless communication method of example 1 further includes the UE dropping the deferred one of the information about TOs' usage and the acknowledgement indication.

### Example 4

The wireless communication method of example 1 further includes the UE transmitting a request for uplink resources to transmit the deferred one of the information about TOs' usage and the acknowledgement indication.

### Example 5

The wireless communication method of any of examples 1 to 4 further includes the UE obtaining a parameter specific to the transmitted one of the information about TOs' usage and the data acknowledgement indication, the parameter being associated with a number of resources within the TO to be used for transmitting the one of the information about TOs' usage and the acknowledgement indication.

### Example 6

The wireless communication method of example 5 that transmits the information about TOs' usage further includes the UE receiving an indicator associated with a value of the parameter, the value pertaining to a set of predefined values.

### Example 7

The wireless communication method of example 5 that transmits the information about TOs' usage further includes receiving a downlink control information (DCI) message activating the at least one TO. Here, the DCI message includes an indicator associated with a value of the parameter.

### Example 8

The wireless communication method of example 7 further includes the UE receiving a radio resource control (RRC) message configuring a number of bits used in the DCI message for the indicator associated with the value of the parameter.

### Example 9

The wireless communication method of example 7 further includes the UE determining a number of bits used in the DCI message for the indicator associated with the value of the parameter, based on a size of a table associating indicator values with parameter instances.

### Example 10

The wireless communication method of example 5 further including the UE receiving an index indicator pointing to a table of values for the parameter specific to the information about TOs' usage.

### Example 11

The wireless communication method of any of examples 1 to 10 is characterized by: the uplink resource grant is a configured grant for physical uplink shared channel, CG-PUSCH, the information about TOs' usage is unused time occasions-uplink control information, UTO-UCI, and the acknowledgement indication includes a hybrid automatic repeat request, HARQ indicating positive acknowledgement, ACK, or negative acknowledgement, NACK.

### Example 12

A wireless communication method performed by a UE includes: (1) receiving a configured grant allocating uplink resources on a first uplink channel, during plural TOs in each of plural configured periods, (2) receiving downlink data, and (3) transmitting, based on the UE is configured not to jointly encode information about TOs' usage and an acknowledgement indication for the downlink data, the acknowledgement indication on a second uplink channel different from the first uplink channel, while refraining from using at least one of the plural TOs to transmit uplink data and the information about TOs' usage.

### Example 13

The wireless communication method of example 12 is characterized by: the first uplink channel is specified in the configured grant as a physical uplink shared channel, CG-PUSCH, the second uplink channel is a physical uplink control channel, PUCCH, the information about TOs' usage is unused time occasions-uplink control information, UTO-UCI, and the acknowledgement indication includes a hybrid automatic repeat request, HARQ indicating positive acknowledgement, ACK, and/or negative acknowledgement, NACK.

### Example 14

A wireless communication method performed by an NE includes: transmitting (1010), to a UE, a configured grant allocating uplink resources in plural TOs during each of plural configured periods, transmitting (1020) downlink data, and receiving (1030), from the UE configured not to jointly encode information about TOs' usage and an acknowledgement indication for the downlink data, one of the information about TOs' usage and the acknowledgement indication encoded into data transmitted using at least one of the plural TOs.

### Example 15

The wireless communication method of example 14 further includes the NE receiving, from the UE, a request for additional uplink resources to transmit another one of the information about TOs' usage and the data acknowledgement indication.

### Example 16

The wireless communication method of any of examples 14 and 15, further comprises transmitting an additional uplink resource grant to the UE.

### Example 17

The wireless communication method of any of examples 14 to 16, further includes the NE receiving, from the UE, another one of the information about TOs' usage and the data acknowledgement indication via another uplink transmission.

### Example 18

The wireless communication method of any of examples 14 to 17, the method further including the NE transmitting, to the UE, an indication for a number of resources within one of the plural TOs to be used for transmitting the information about TOs' usage.

### Example 19

The wireless communication method of any of examples 14 to 18, is characterized by the configured grant is a configured grant for physical uplink shared channel, CG-PUSCH, the information about TOs' usage is unused time occasions-uplink control information, UTO-UCI, and the acknowledgement indication includes a hybrid automatic repeat request, HARQ indicating positive acknowledgement, ACK, and/or negative acknowledgement, NACK.

### Example 20

A wireless communication device (such as, NE 210 and UE 220 in FIG. 2) includes a transceiver (such as, 212, and 222 in FIG. 2), a processor (such as, 213, and 223 in FIG. 2), and computer-readable storage media (such as, 214, and 224 in FIG. 2) storing executable instructions (such as 216, 217, 226, 227 in FIG. 2) for the processor to perform any of the methods in examples 1-19, using the transceiver.

The above-described embodiments may be integrated in the 3GPP technical specifications (TSs) in the following manner. The TS 38.213 section 9.3 may include the following modified text (added text is emphasized): “Offset values are defined for a UE to determine a number of resources for multiplexing HARQ-ACK information and for multiplexing CSI reports in a PUSCH. Offset values are also defined for multiplexing CG-UCI [5, TS 38.212] in a CG-PUSCH or UTO-UCI in a CG-PUSCH. The offset values are signalled to a UE either by a DCI format scheduling the PUSCH transmission or by higher layers.”

The same section TS 38.213 section 9.3 should include the following additional text: “If the PUSCH transmission is with a configured grant and the UE is provided UTO-UCI-OnPUSCH=‘semiStatic’, and if the UTO-UCI-Multiplexing is not configured, the UE applies the

$${β}_{offset}^{UTO - UCI}$$

value that is provided by UTO-UCI-OnPUSCH=‘semiStatic’ for the corresponding UTO-UCI information (and the HARQ-ACK information is dropped or delayed). If the PUSCH transmission is with a configured grant and the UE is provided CG-UCI-OnPUSCH=‘semiStatic’, and if the UTO-UCI-Multiplexing is configured, the UE applies the

$${β}_{offset}^{HARQ - ACK}$$

value that are provided by CG-UCI-OnPUSCH=‘semiStatic’ to multiplex the HARQ-ACK information and UTO-UCI information on PUSCH.

Another portion added to the same TS 38.213 section 9.3 should read: “If the PUSCH transmission is a configured grant Type 2 PUSCH and the UE is provided UTO-UCI-OnPUSCH=‘dynamic’, and if the UTO-UCI-Multiplexing is not configured, the UE applies the

$${β}_{offset}^{UTO - UCI}$$

value that is provided by UTO-UCI-OnPUSCH=‘dynamic’ for the corresponding UTO-UCI information (and the HARQ-ACK information is dropped or delayed). If the PUSCH transmission is a configured grant Type 2 PUSCH and the UE is provided UTO-UCI-OnPUSCH=‘dynamic’, and if the UTO-UCI-Multiplexing is configured, the UE applies the value

$${β}_{offset}^{HARQ - ACK}$$

value that are provided by CG-UCI-OnPUSCH=‘dynamic’ to multiplex the HARQ-ACK information and UTO-UCI information on PUSCH.”

In addition to these potential changes of TS 38.213, a subsection entitled “UTO-UCI-Multiplexing” of TS 38.331 should state: “When configured, in the case of PUCCH overlapping with a CG-PUSCH TO(s) within a PUCCH group, the UTO-UCI and HARQ-ACK are jointly encoded (UTO-UCI is treated as the same type as a HARQ-ACK) and the HARQ-ACK beta offset is used in the procedures. When not configured, in the case of PUCCH overlapping with CG-PUSCH TO(s) within a PUCCH group and PUCCH carries HARQ ACK feedback, UTO-UCI and HARQ-ACK are not jointly encoded, the UTO-UCI beta offset is used for the “UTO-UCI” encoding.”

The definition of ConfiguredGrantConfig information element (IE) in 38.331 should be modified to include:

| | < Unchanged parts are omitted > |
|---|---|
| uci-OnPUSCH | SetupRelease { CG-UCI-OnPUSCH } |
| OPTIONAL, -- Need S | |
| uci-OnPUSCH | SetupRelease { UTO-UCI-OnPUSCH } |

OPTIONAL, -- Need M

and further specifying relative to uto-uci-OnPUSCH that: “When UTO-UCI-Multiplexing is not configured, uto-uci-OnPUSCH allows for the selection between and configuration of dynamic and semi-static beta-offset for UTO-UCI. For Type 1 UL data transmission without grant, uto-uci-OnPUSCH should be set to semiStatic.”

The TS 38.306 should specify that (i) semi-staticBetaOffsetInd-UTO-UCI “indicates whether the UE supports indicating beta-offset for UTO UCI via RRC configuration,” and (ii) dynamicBetaOffsetInd-UTO-UCI “indicates whether the UE supports indicating beta-offset for UTO UCI via DCI among the RRC configured betaoffsets for UTO UCI.”

Further, TS 38.212 should include an additional new DCI bit-field for the new beta offset. For example, TS 38.212 subsection 7.3.1.1.2 Format 0_1 could include the following additional language: “beta_offset indicator-UTO-UCI−0 if the higher layer parameter betaOffsets=semiStatic (or a dedicated RRC parameter for UTO-UCI instead of betaOffsets); otherwise N bits (where Nis pre-defined or RRC configured).” The same TS 38.212 should also include the following added text: “When higher layer parameter UTO-UCI-Multiplexing is configured, the UCI bit sequence a₀, a₁, a₂, a₃, . . . , a_{A-1} is determined as follows, where A=O^{UTO-UCI}+O^{ACK}. (A) The UTO-UCI bits are mapped to the UCI bit sequence a₀, a₁, a₂, a₃, . . . , a_{O}_{^{UTO-UCI}}₋₁, where

$${a}_{i} = {\tilde{o}}_{i}^{UTO - UCI}$$

for i=0, 1, . . . , O^{UTO-UCI}−1. The UTO-UCI bit sequence

$${\tilde{o}}_{0}^{UTO - UCI} , {\tilde{o}}_{1}^{UTO - UCI} , … , {\tilde{o}}_{{o}^{UTO - UCI} - 1}^{UTO - UCI}$$

is given by a bitmap (where a bit corresponds to a TO within a time duration/range) mapped in the order from upper part to lower part, and O^{UTO-UCI} is number of UTO-UCI bits. (B) The HARQ-ACK bits are mapped to the UCI bit sequence a_{O}_{^{UTO-UCI}}, a_{O}_{^{UTO-UCI}}₊₁, . . . , a_{O}_{^{UTO-UCI}}_{+O}_{^{ACK}}₊₁, where

$${a}_{i + {O}^{UTO - UCI}} = {\tilde{o}}_{i}^{ACK} for i = 0 , 1 , … , {O}^{ACK} - 1.$$

The HARQ-ACK bit sequence

$${\tilde{o}}_{0}^{ACK} , {\tilde{o}}_{1}^{ACK} , … , {\tilde{o}}_{{O}^{ACK} - 1}^{ACK}$$

is given by Clause 9.1 of [5, TS38.213], and O^{ACK} is number of HARQ-ACK bits.”

Numerical adjectives “first”, “second”, and “third” do not imply any order (are not ordinals) but are markers to distinguish separate instances of similar elements. References to the singular (e.g., “a” or “an”, “the”) should include the plural unless clearly indicated otherwise.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

1-15. (canceled)

16. A wireless communication method performed by a user equipment, UE, the method comprising:
receiving a configured grant allocating uplink resources in plural transmission occasions, TOs, during each of plural configured periods;
obtaining a parameter specific to one of information about TOs' usage and an acknowledgement indication to be transmitted, the parameter being associated with a number of resources within a TO to be used for transmitting the one of the information about TOs' usage and the acknowledgement indication;
receiving downlink data; and
transmitting, based on the UE being configured not to jointly encode the information about TOs' usage and the acknowledgement indication for the downlink data, one of the information about TOs' usage and the acknowledgement indication in at least one of the TOs while deferring the other one of the information about TOs' usage and the acknowledgement indication.

17. The method of claim 16, further comprising:
transmitting the deferred one of the information about TOs' usage and the acknowledgement indication using another uplink transmission.

18. The method of claim 16, further comprising:
dropping the deferred one of the information about TOs' usage and the acknowledgement indication.

19. The method of claim 16, further comprising:
transmitting a request for additional uplink resources to transmit the deferred one of the information about TOs' usage and the acknowledgement indication.

20. The method of claim 16, wherein the information about TOs' usage is transmitted, and the method further comprises:
receiving an indicator associated with a value of the parameter, the value pertaining to a set of predefined values, or
receiving an index indicator pointing to a table of values for the parameter specific to the information about TOs' usage.

21. The method of claim 16, wherein the information about TOs' usage is transmitted, and the method further comprises:
receiving a downlink control information, DCI, message activating the configured grant, the DCI message including an indicator associated with a value of the parameter.

22. The method of claim 21, further comprising:
receiving a radio resource control, RRC, message configuring a number of bits used in the DCI message for the indicator associated with the value of the parameter, or
determining a number of bits used in the DCI message for the indicator associated with the value of the parameter, based on a size of a table associating indicator values with parameter instances.

23. The method of claim 16, wherein the configured grant is a configured grant for physical uplink shared channel, CG-PUSCH, the information about TOs' usage is unused transmission occasion-uplink control information, UTO-UCI, and the acknowledgement indication includes a hybrid automatic repeat request, HARQ, indicating positive acknowledgement, ACK, or negative acknowledgement, NACK.

24. The method of claim 16, further comprising:
transmitting, based on the UE being configured not to jointly encode information about TOs' usage and an acknowledgement indication for the downlink data, the acknowledgement indication on a second uplink channel different from a first uplink channel, while refraining from using at least one of the plural TOs to transmit uplink data and the information about TOs' usage.

25. The method of claim 24, wherein the first uplink channel is specified in the configured grant as a physical uplink shared channel, CG-PUSCH, the second uplink channel is a physical uplink control channel, PUCCH, the information about TOs' usage is unused transmission occasion-uplink control information, UTO-UCI, and the acknowledgement indication includes a hybrid automatic repeat request, HARQ, indicating positive acknowledgement, ACK, or negative acknowledgement, NACK.

26. A wireless communication method performed by a network entity, NE, the method comprising:
transmitting, to a user equipment, UE, a configured grant allocating uplink resources in plural transmission occasions, TOs, during each of plural configured periods;
transmitting a parameter specific to one of information about TOs' usage and an acknowledgement indication for downlink data, the parameter being associated with a number of resources within a TO to be used for transmitting the one of the information about TOs' usage and the acknowledgement indication;
transmitting downlink data; and
receiving, from the UE configured not to jointly encode the information about TOs' usage and the acknowledgement indication for the downlink data, one of the information about TOs' usage and the acknowledgement indication transmitted using at least one of the plural TOs while the other one of the information about TOs' usage and the acknowledgement indication is deferred or dropped.

27. The method of claim 26, wherein the information about Tos' usage is transmitted, and the method further comprises:
transmitting an indicator associated with a value of a parameter specific to the transmitted one of the information, the parameter being associated with a number of resources within the TO to be used for transmitting the one of the information, the value pertaining to a set of predefined values, or
transmitting an index indicator pointing to a table of values for the parameter specific to the information about Tos' usage.

28. The method of claim 26, wherein the configured grant is a configured grant for physical uplink shared channel, CG-PUSCH, the information about TOs' usage is unused transmission occasion-uplink control information, UTO-UCI, and the acknowledgement indication includes a hybrid automatic repeat request, HARQ, indicating positive acknowledgement, ACK, or negative acknowledgement, NACK.

29. A user equipment (UE) apparatus comprising:
a transceiver; and
a processor coupled to the transceiver and configured to:
receive a configured grant allocating uplink resources in plural transmission occasions, TOs, during each of plural configured periods,
obtain a parameter specific to one of information about TOs' usage and an acknowledgement indication to be transmitted, the parameter being associated with a number of resources within a TO to be used for transmitting the one of the information about TOs' usage and the acknowledgement indication,
receive downlink data, and
transmit, based on the UE being configured not to jointly encode the information about TOs' usage and the acknowledgement indication for the downlink data, one of the information about TOs' usage and the acknowledgement indication in at least one of the TOs while deferring the other one of the information about TOs' usage and the acknowledgement indication.

30. The UE apparatus of claim 29, wherein the processor is further configured to transmit the deferred one of the information about TOs' usage and the acknowledgement indication using another uplink transmission.

31. The UE apparatus of claim 29, wherein the processor is further configured to drop the deferred one of the information about TOs' usage and the acknowledgement indication.

32. The UE apparatus of claim 29, wherein the processor is further configured to transmit a request for additional uplink resources to transmit the deferred one of the information about TOs' usage and the acknowledgement indication.

33. A network entity (NE) apparatus comprising:
a transceiver; and
a processor coupled to the transceiver and configured to:
transmit, to a user equipment (UE), a configured grant allocating uplink resources in plural transmission occasions, TOs, during each of plural configured periods,
transmit a parameter specific to one of information about TOs' usage and an acknowledgement indication for downlink data, the parameter being associated with a number of resources within a TO to be used for transmitting the one of the information about TOs' usage and the acknowledgement indication,
transmit downlink data, and
receive, from the UE configured not to jointly encode the information about TOs' usage and the acknowledgement indication for the downlink data, one of the information about TOs' usage and the acknowledgement indication transmitted using at least one of the plural TOs while the other one of the information about TOs' usage and the acknowledgement indication is deferred or dropped.

34. The NE apparatus of claim 33, wherein the information about TOs' usage is transmitted, and the processor is further configured to:
transmit an indicator associated with a value of a parameter specific to the transmitted one of the information, the parameter being associated with a number of resources within the TO to be used for transmitting the one of the information, the value pertaining to a set of predefined values, or
transmit an index indicator pointing to a table of values for the parameter specific to the information about TOs' usage.

35. The NE apparatus of claim 33, wherein the configured grant is a configured grant for physical uplink shared channel, CG-PUSCH, the information about TOs' usage is unused transmission occasion-uplink control information, UTO-UCI, and the acknowledgement indication includes a hybrid automatic repeat request, HARQ, indicating positive acknowledgement, ACK, or negative acknowledgement, NACK.
